(19) United States
(12) Patent Application Publication
(10) Pub. No.: US 2008/0059537 A1
(43) Pub. Date: Mar. 6, 2008

(54) Content subscription

(76) Inventors: Juergen Sattler, Wiesloch (DE); Joachim Gaffga, Wiesloch (DE); Werner Wolf, Wiesloch (DE); Robert Viehmann, Waghausl (DE); Frank Markert, Grossostheim (DE)

Correspondence Address: SCHWEGMAN, LUNDBERG & WOESSNER/SAP, P.O. BOX 2938, MINNEAPOLIS, MN, 55402, US

(21) Appl. No.: 11/512,519

(22) Filed: Aug. 29, 2006

(51) Int. Cl. G06F 17/30

(52) U.S. Cl. 707/200

(57) ABSTRACT

The present subject mater relates to configuring computer applications and, more particularly, computer application content subscription. The various embodiments herein provide systems, methods, and software that maintain a representation of configuration settings in a database of one or more application instance configurations and receive new content, wherein the new content is linked to one or a combination of relevant configuration settings. Some such embodiments also identify application instances to receive the new content as a function of the relevant configuration setting links of the new content and the representation of configuration settings in the database and distribute the new content to the identified application instances.

### TECHNICAL FIELD

The present subject mater relates to configuring computer applications and, more particularly, computer application content subscription.

### BACKGROUND INFORMATION

Computer applications developed by software companies are commonly updated. These updates can include bug fixes, additional functionality, new versions of all or part of a system, and other such updates. Distributing such updates in years past was performed by loading an install or upgrade program from a computer disk and executed upon an application. With the growth of Internet connectivity, the install or update programs have been downloadable from support websites of software companies.

More recently, software companies have provided programs that execute within applications that aware of a status of an application and check for updates available for download. Such programs provide a notice to a system user when one or more updates are available. Some such programs automatically download the updates and install them. However, this requires the program to execute within the system to identify when updates are available. The program may only execute on a periodic basis. As a result, the program may not be aware of updates for a lengthy period.

### BRIEF DESCRIPTION OF THE DRAWINGS

FIG. 1 is a block diagram of a system according to an example embodiment.

FIG. 2A is a block diagram of a system according to an example embodiment.

FIG. 2B is a block diagram of a system according to an example embodiment.

FIG. 2C is a block diagram of a system according to an example embodiment.

FIG. 3 is a block diagram of a system according to an example embodiment.

FIG. 4 is a flow diagram of a method according to an example embodiment.

FIG. 5 is a block diagram of a system according to an example embodiment.

### DETAILED DESCRIPTION

The various embodiments described herein provide systems, methods, and software that enable a content subscription service for a computer application. In some embodiments, such content includes application upgrade programs, bug fixes, additional functionality, user interfaces, adaptation catalog entries, forms, reports, configuration settings, and virtually any other computer readable data or executable instructions relevant to the application.

In some embodiments, a content subscription includes a process to automatically distribute content to an application. In some such embodiments, when content is distributed, the content is automatically installed to the application. In other embodiments, a notice sent to system administrator when an update is available. In other embodiments, content updates are placed in an inbox that can be automatically or manually downloaded to application instances.

Content updates in such embodiments are distributed only to affected application instances. This is facilitated by maintaining a representation of current application instance configurations in a database. When an item of content is published to the content subscription server, a process of a content subscription module can execute upon the published content and determine which application instances the published content is relevant to. The content can then be pushed to those instances, the content can be placed in a content inbox for download by the application instance or instance administrator, or a notice can be sent to administrators of the identified application instances notifying them that new content relevant to their application instance is available. These and other embodiments are described herein.

In the following detailed description, reference is made to the accompanying drawings that form a part hereof, and in which is shown by way of illustration specific embodiments in which the inventive subject matter may be practiced. These embodiments are described in sufficient detail to enable those skilled in the art to practice them, and it is to be understood that other embodiments may be utilized and that structural, logical, electrical, or other changes may be made without departing from the scope of the inventive subject matter. Such embodiments of the inventive subject matter may be referred to, individually and/or collectively, in the present application by the term “invention” merely for convenience and without intending to voluntarily limit the scope of this application to any single invention or inventive concept if more than one is in fact disclosed.

The following description is, therefore, not to be taken in a limited sense, and the scope of the inventive subject matter is defined by the appended claims.

The functions or algorithms described in the present application are implemented in hardware, software or a combination of software and hardware in one or more embodiments. The software comprises computer executable instructions stored on computer readable media such as memory or other type of storage devices. The term “computer readable media” is also used to represent carrier waves on which the software is transmitted. Further, such functions correspond to modules, which may be one or more, or a combination of, software, hardware, or firmware. Multiple functions are performed in one or more modules as desired, and the embodiments described are merely examples. The software may be executed on a digital signal processor, ASIC, microprocessor, or other type of processor operating on a system, such as a personal computer, server, a router, or other device capable of processing data including devices interconnected by a network.

Some embodiments implement the functions in two or more specific interconnected hardware modules or devices with related control and data signals communicated between and through the modules, or as portions of an application-specific integrated circuit. Thus, the exemplary process flow is applicable to software, firmware, and hardware implementations.

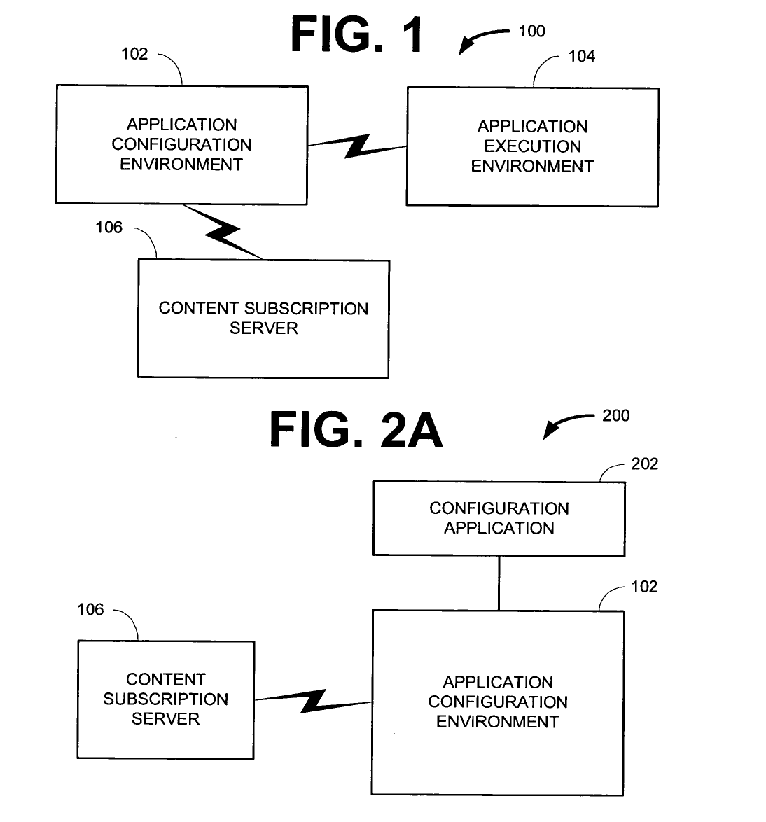

FIG. 1 is a block diagram of a system 100 according to an example embodiment. The system 100 includes an application configuration environment 102, an application execution environment 104, and a content subscription server 106.

The application configuration environment 102 is a system 100 environment within which an application can be configured. However, the application will, or does, execute within the application execution environment 104. In some embodiments, this arrangement of the application configuration environment 102 and the application execution environment 104 separates the configuration of an application from the environment within which it executes. When an application configuration has been established, all or part of the configuration can then be deployed to the application execution environment 104. This deployment can occur to one or more separate instances of the application in the application execution environment 104. Although only a single application execution environment 104 is illustrated, multiple application execution environments 104 may exists, and the deployment can be made to one or more of the multiple application execution environments 104.

The content subscription server 106 typically receives content updates and new content from content authors, or through a content authoring process, then publishes the content to the content subscription server 106. When content is published to the content subscription server 106, the content may include metadata identifying what portions of an application the content is relevant to or otherwise has an effect upon. In some embodiments, the metadata typically identifies a version of an item of content, such as version 2.0 of a previously existing item of content. In such instances, the new version of the content is backward compatible with previous versions of the application instance to ensure that new content does not adversely affect a previously stable application instance.

The content subscription server 106 may further includes a database, or has access to a database, including data representative of application instance configurations. In some such embodiments, the data representative of the application instance configurations may include data representative of content deployed to the respective application instances.

The content subscription server 106 may further include a content subscription module that evaluates the metadata of received content updates and new content. As mentioned above, this metadata typically identifies application portions the content is relevant to or otherwise has an effect upon. The content subscription module may then query the database including the representations of application instance configurations to determine which application instances the new content is relevant to. The new content may then be distributed to the application configuration environments of the identified application instances. The application configuration environment may then deploy the new content.

In some embodiments, the content subscription server 106 may further include a database of content subscription preferences. In some such embodiments, when an application instance is instantiated, an application administrator, or other individual, may set up a content subscription. A content subscription typically includes a specification of content subscription preferences that are typically stored in the content subscription preference database. These preferences may identify how to handle new content when new content is published to the content subscription server 106.

In some embodiments, the content subscription preferences may specify that new content that is identified by the content subscription module to be relevant to the application instance be pushed to the application configuration environment 102 over a network, such as the Internet. When new content is pushed to the application configuration environment, an example content subscription preference specifies that the new content it to be automatically deployed to the application execution environment 104 by a deployment process. In other embodiments, the preferences may specify that the pushed content is to be stored in an administrator inbox. In these embodiments, the administrator, or other individual, may manually instruct the deployment module to deploy the new content. In some other embodiments, a content subscription preference may specify that the new content to be placed in a new content inbox. The new content inbox may be located on the content subscription server 106 or other server from which the new content may be accessed for download.

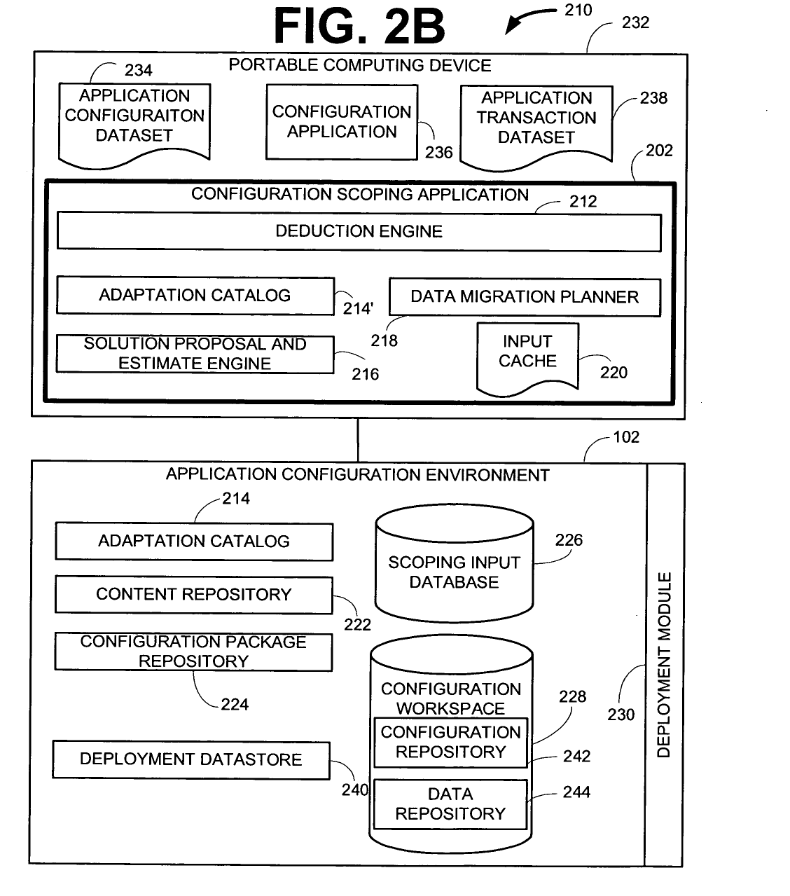

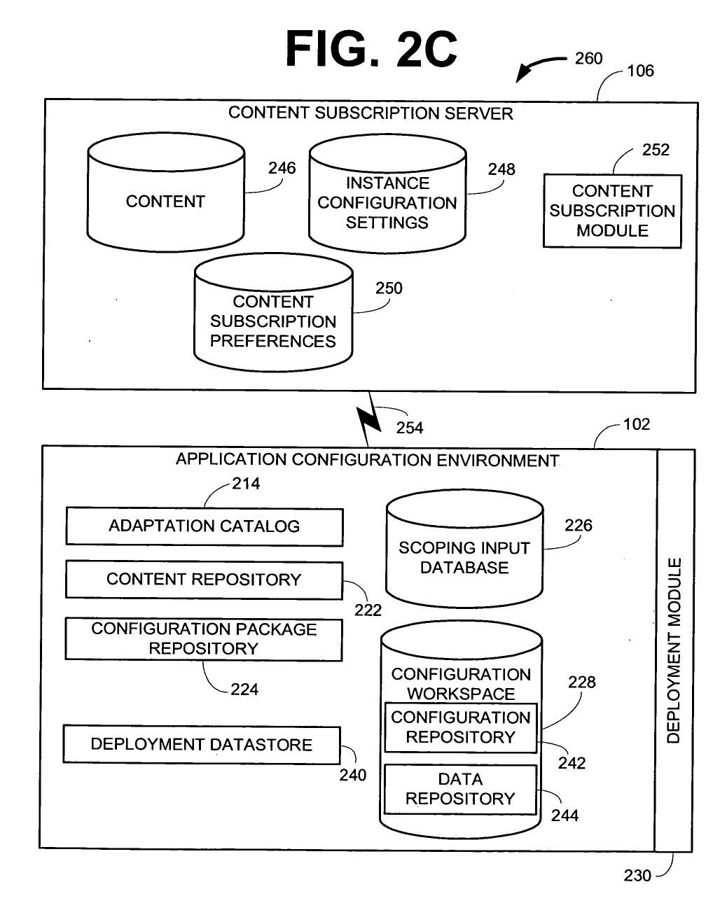

FIG. 2A is a block diagram of a system 200 according to an example embodiment. The system 200 includes a configuration scoping application 202, the application configuration environment 102, and the content subscription server 106.

The configuration scoping application 202 typically is a software tool that executes on a computing device, such as a portable computer, on a same computing device within which the application configuration environment 102 exists, or on another computing device that can be communicatively coupled to the application configuration environment 102.

The configuration scoping application 202, when executed, typically presents a set of scoping questions to a user. The scoping questions ma be linked to one of many adaptation catalog entries. The adaptation catalog entries may include a representation of all of the solution capabilities of an application to be configured, and eventually executed. In some embodiments, the solution capabilities are hierarchically divided into areas, packages, topics, and options. There may be multiple areas, and each area may have multiple packages. Each package may have multiple topics, and each topic may have multiple options.

In some embodiments, such as in an example embodiment where the application to be configured is an ERP application, the adaptation catalog may provide in the area Sales, a package Customer Order Management that contains the topics Sales Order Quote, Sales Order, Sales Order Analysis, and others. On that level, one or more options typically exist such as Approval Processing.

In the configuration scoping application 202, as stated above, scoping question may be linked to an adaptation catalog entry. An adaptation catalog entry further includes a rule. These rules typically model dependencies between the areas, packages, topics, and options and corresponding solution capabilities of the application. A rule can may specify required inclusion or exclusion of other areas, packages, topics, or options, or may require specification of further areas, packages, topics, or options. A rule may also specify a recommendation or default area, package, topic, or option.

For example, a first example scoping question, “What is the primary focus of your business?” may have three possible answers including “Sales,” “Service,” and “Logistics.” Such a first scoping question typically is aimed at identifying an area of business in which the application is going to be used. Answering “Sales” typically tells the configuration scoping application 202 that the area is “Sales” and a rule tied to the adaptation catalog entry for “Sales” specifies dependencies with packages, topics, and options and the corresponding solution capabilities of the application necessary or optional in using the application in a sales business. Such a rule can also specify that other packages, topics, and options and the corresponding solution capabilities be excluded.

Thus, when a user answers scoping questions, the configuration of the application is being performed. Further, when a question is answered that is associated with an adaptation catalog entry having a rule that excludes another area, package, topic, or option, that rule may be applied to eliminate questions from consideration. Conversely, when a question is answered that is associated with an adaptation catalog entry having a rule that requires another area, package, topic, or option, that same rule may be applied to determine a next question, or group of questions, to ask a user. However, in the event that a question is not answered that is linked to a rule providing defaults, the question may be skipped without adversely affecting the application configuration.

In some embodiments, the answers to the scoping questions answers may be stored in a location accessible to the content subscription server 106. This may include storing the scoping question answers on the content subscription server 106 and the content subscription server 106 being able to access the scoping question answers within the application configuration environment 102.

The answers to the configuration scoping questions may be used by a content subscription module process to identify new content that is relevant to one or more application instances. The identification of new content that is relevant to one or more application instances may occur when the new content includes new functionality not previously linked to a scoping question answer in the adaptation catalog.

FIG. 2B is a block diagram of a system 210 according to an example embodiment. The system 210 includes a portable computing device 232 including a configuration application 236, an application configuration dataset 234 stored in a memory, an application transaction dataset 238 and the configuration scoping application 202. The system 210 further includes the application configuration environment 102. Although the application configuration environment 102 is not illustrated within the portable computing device 232, in some embodiments, the application configuration environment 102 may reside within the portable computing device 232. In other embodiments, the application configuration environment 102, the configuration scoping application 202, the application configuration dataset 234, the configuration application 236, and the application transaction dataset 238 may all reside on a computing device other than the portable computing device 232.

The configuration application 236, in some embodiments, typically provides a set of tools via user interfaces to a user. The tools of the configuration application 236 may allow the user to modify answers to scoping question answers stored in an input cache 220 of the configuration scoping application 202, the application configuration dataset 234, and the application transaction dataset 238. The application configuration dataset 234 may be populated with data copied from a configuration repository 242 stored within a configuration workspace 228 of the application configuration environment 102. The application transaction dataset 238 may be populated with data copied either from a demonstration dataset stored in data repository 244 of the configuration workspace 228 or from the content repository 222.

Although the input cache 220 is illustrated within the configuration scoping application 202, the input cache 220 may exist separate from the configuration scoping application 202 within a memory of the portable computing device 232. In such embodiments, the input cache 220 may be populated with data copied from the scoping input database 226.

For the sake of understandability regarding several portions of the configuration scoping application 202 and the application configuration environment 102, these portions of the system 210 will be discussed followed by a more detailed discussion of the configuration application 236.

The configuration scoping application 202, in some embodiments, includes a deduction engine 212 and an adaptation catalog 214′. In this embodiment, the configuration scoping application 202 further typically includes a solution proposal and estimate engine 216, a data migration planner 218, and the input cache 220.

The application configuration environment 102, in some embodiments, includes an adaptation catalog 214, a content repository 222, and a configuration package repository 224. In some such embodiments, the application configuration environment 102 further includes a scoping input database 226, a configuration workspace 118, a deployment module 230, and a deployment datastore 240.

The adaptation catalog 214 may include a representation of all of the solution capabilities of an application to be configured, and eventually executed. Each capability of an application to be configured is identified in an adaptation catalog 214 entry. The adaptation catalog 214 entries each may be identified as an area, package, topic, or option and may be organized in a hierarchy with a child identifying the parent. An example hierarchy is a “General Ledger” capability, which in some embodiments typically is a package having two topics, “cash based” and “accrual based” which are two application capabilities within the “General Ledger” capability.

The adaptation catalog 214 entries may further include scoping questions directed toward obtaining scoping information to determine what areas, packages, topics, and options are relevant to the user's needs. Additionally, the adaptation catalog entries typically include rules, the application of which can require inclusion or exclusion, or specify default inclusion or exclusion, of certain other areas, packages, topics, and options. Thus, because the areas, packages, topics, and options correlate to application capabilities, the inclusion, exclusion, and defaulting specifies what capabilities will be enabled and disabled in the application when deployed by the deployment module 230.

In some embodiments, rules and entries in the adaptation catalog can be linked to a configuration package that exists in the configuration package repository 224. A configuration package includes one or more configuration settings that enable or disable functionality of the application when deployed by the deployment module 230 or by a configuration process within the application configuration environment 102 when configuring the application within the configuration workspace 228. A configuration package can further be linked to one or more content items or content item definitions stored in the content repository 222. Some such content types include report layouts, forms, user interfaces, communication specifications, documentation, and other content that can be used in an application when deployed. A communication specification can include an XML schema, an EDI schema and connectivity information, mappings between file layouts and application data storage mechanisms, such as databases, and other similar communication specifications.

The rules of adaptation catalog 214 entries may also be used by the deduction engine 212 of the configuration scoping application 202. The configuration scoping application 202 typically presents a user interface to a user that requests answers to questions. The questions to be asked via the user interface may be identified by the deduction engine 212 based on the adaptation catalog 214′. The adaptation catalog 214′ is typically a copy of the adaptation catalog 214 from the application configuration environment 102. When an answer is received by the configuration scoping application 202 through the user interface, the answer may be stored in the input cache 220 of the configuration scoping application 202. The deduction engine 212 may then apply the rule associated with the adaptation catalog 214′ entry of the question asked to the received answer. Through the application of the rule, in view of answers already received and rules already applied, the deduction engine 212 typically identifies a next question to ask. The identified question may then be presented to the user through the user interface. This process typically continues until either all of the questions have been asked, the user is out of time, or otherwise chooses to stop. If questions remain that have not been answered, the process may be continued at a later time or rules specifying default areas, packages, topics, and options typically supply enough information to allow deployment of the application in a functional form.

In some embodiments, the configuration scoping application 218 may further include a data migration planner 218. In such embodiments, one or more additional scoping questions may be asked. These additional scoping questions are typically directed toward obtaining information from the user about legacy systems and how data is stored within them. In some embodiments, the questions simply may ask what systems are currently in use. In other embodiments, the questions may be more detailed to obtain information such as what type of database an application is utilizing and what type of customization has been made or custom applications developed. The data migration planner 218 may then use the answers to these additional questions to propose a data migration plan to the new application.

In some embodiments, the configuration scoping application 202 includes a solution proposal and estimate engine 216. The solution proposal and estimate engine 216 may be used in a sales situation. For example, if a sales person is discussing with a sales lead what a certain application product can do for the sales lead, the sales person typically can utilize the configuration scoping application 202 to obtain information about the needs of the sales lead via the scoping questions. The scoping question answers may then be utilized by the solution proposal and estimate engine 216 to make an initial determination of what will be involved if the sales lead decides to purchase the application. The solution proposal and estimate engine 216 normally is configured to output information for the sales lead to make several determinations, such as the size of effort necessary to implement or transition to the application from legacy system, the cost involved, and cost. In some embodiments, the output of the solution proposal and estimate engine 216 outputs one or more of an implementation cost estimate, an application solution proposal, and a recommended project roadmap. In some embodiments, the solution proposal and estimate engine 216 outputs a proposal for one or more other options, application descriptions, sales literature, benefit statements of using the application, and addition documents, such as a proposal of key performance indicators the application can monitor to assist in managing the application or enterprise of the sales lead.

After the scoping question have been answered, the answers, and any other information obtained from a sales lead or other user of the configuration scoping application 202, the information typically is uploaded to the application configuration environment 102. However, in embodiments, where the configuration scoping application 202 executes on the same computing device as the application configuration environment 202, the scoping question answers and other information may be stored directly to the application configuration environment 102.

When the configuration question answers and other information is uploaded, or otherwise stored to the application environment 102, the scoping question answers are stored to the scoping input database 226. The scoping question answers, in some instances, will be referred to interchangeably as the “scoping information.”

After the scoping information is within the scoping input database 226, a process within the application configuration environment 102 typically executes to begin configuring an application in the configuration repository 242 of the configuration workspace 228. The configuration repository 242 may include a set of configuration tables that mirrors, at least in part, the configuration tables of the application. The configuration repository 242 may include a set of configuration tables for each of multiple instances of the application to allow use of the application configuration environment 102 to configure multiple application instances.

The process that configures the application may be configured to determine one or more configuration packages to instantiate in the configuration repository 242. Configuration packages, in some embodiments, may include one or a set of configuration settings to enable or disable certain capabilities of the application. Configuration packages, as mentioned above, may be linked to adaptation catalog 214 entries and rules associated with adaptation catalog entries. Thus, the process that configures the application in the configuration repository 242 may be configured to query the scoping information in the scoping input database 226 to identify configuration packages to instantiate.

In some embodiments, demonstration data may exist to facilitate instantiation of a demonstration instance of the application for a sales lead, training session, or other purpose. The demonstration data, in some embodiments, is linked to one or more configuration packages from the configuration package repository 224. The demonstration data typically exists in the content repository 222 so that it can be copied into a set of application tables in the data repository 244 of the configuration workspace 228. These tables may hold such data as transactional data, operational data, master data, or other data that can exist in the application when the application is ready for execution or is executed.

Once the demonstration data is copied to the data repository 244, that data may be fine-tuned to more closely match the intended use of the demonstration data. For example, the system may be configured so that a sales person, or other individual, can fine-tune demonstration data values to more closely match a sales lead's expectations of the application. Such fine tuning may include modifying sales order documents in the demonstration data to include a name, address, and logo of the sales lead's enterprise, or other similar modifications to the demonstration data.

Some embodiments of the application configuration environment 102 may further include the deployment datastore 240. The deployment datastore 240 typically stores a representation of one or more application configurations of applications that have been deployed. The representations of the one or more application configuration may be stored or updated in the deployment datastore 240 by the deployment module 230 upon successful deployment of an application.

A representation of an application configuration typically includes data representative of the application configuration settings. In some embodiments, the representation may further include data representative of content deployed to the application.

The deployment datastore 240, in some embodiments, may be updated upon each configuration or content modification of a deployed system. In some embodiments, the deployment datastore may further include a versioning mechanism that maintains not only a current configuration representation, but also historical representations.

In some embodiments, the deployment datastore 240, or a current copy thereof, may be maintained by an entity that developed, or otherwise offers for sale, the application. The deployment datastore 240 may be used by the entity to monitor current application usage, perform billing processes as a function of a current application configuration, provide application upgrade information based on portions of the application or content utilized, and for other purposes. In some embodiments, the entity may provide application updates, bug fixes, or other upgrades directly to a deployed application instance. Such updates, bug fixes, or other upgrades may be identified as relevant to a particular application instance as a function of the configuration representation in view of adaptation catalog 214 entries.

As described above, the configuration application 236, in some embodiments, may provide a set of tools via user interfaces to a user. The tools of the configuration application 236 typically allow the user to modify answers to scoping question answers stored in an input cache 220, the application configuration dataset 234, and the application transaction dataset 238. The application configuration dataset 234 may be populated with data copied from the configuration repository 242. The application transaction dataset 238 may be populated with data copied from either a demonstration dataset stored in the data repository 244 or from the content repository 222. The input cache 220, if separate from the configuration scoping application 202 may be populated with scoping information copied from the scoping input database 226.

Through use of the configuration application 236 user interfaces, a user may modify data within the application transaction dataset 238 to customize the data used of a demonstration application to more closely reflect how a sales lead's enterprise will use the application. For example, through modifying the transaction data, data displayed within the demonstration may include orders with products, customers, addresses, countries, and other details that truly reflect those of the sales lead's enterprise.

Further, use of the configuration application 236 user interfaces may also allow a user to further refine an application configuration to more closely match the needs of a customer or sales lead. This can include a user taking a copy of an application configuration to work on while away from a connection to the application to be configured or application configuration environment 102, such as when traveling.

In some embodiments, the configuration application 236 may further include a warehouse-modeling module. The warehouse-modeling module may include a deduction engine 212 and a subset of an adaptation catalog 214 as discussed above, or may leverage the deduction engine 212 and adaptation catalog 214′ of the configuration scoping application 202 if present on the portable computing device 232. In such embodiments, the adaptation catalog 214 (or 214′) may further include one or more area, package, topic, option hierarchies of adaptation catalog 214 entries. The user may answer scoping questions to identify and define a warehouse layout and processes utilized within a warehouse to be modeled. Such warehouse modeling data, once defined, may be copied to the data repository. In some embodiments, such information is similar to configuration settings as a warehouse layout is not subject to frequent change. However, warehouse layouts are generally unique to each warehouse. Thus, warehouse data may be stored in the data repository and may be deployed to an application data table instead of a configuration table.

FIG. 2C is a block diagram of a system 260 according to an example embodiment. The system 260 includes the application configuration environment 102 as described above with reference to FIG. 1, FIG. 2A, and FIG. 2B. The system 260 further includes the content subscription server 106 as described above with reference to FIG. 1 and FIG. 2A, but provides greater detail with regard to the various elements of the content subscription server according to some embodiments.

The content subscription server may include a content database 246, a database of application instance configurations 248, a database of content subscription preferences, and a content subscription module 252. Some further embodiments may also include a copy of the scoping input database 226. Yet further embodiments may include an inbox module providing a location to place new content for download by an administrator or process of an application configuration environment 102.

The content subscription server 106 is typically operatively coupled to the application configuration environment 102. In some embodiments, the coupling of the content subscription server 106 to the application configuration environment 102 may be made over a network connection 254 between the computing systems upon which they operate. In some embodiments, the network connection 254 is an Internet connection. In other embodiments, the network connection 254 may a connection to one or more of a variety of networks including a local area network (“LAN”), a wide area network (“WAN”), a value added network (“VAN”), a peer-to-peer network (“P2P”), or other suitable network providing data exchange functionality.

The content database 246 typically is a location to which new content is published. Content published to the content database 246 is content that may be processed by the content subscription module 252 and pushed, or otherwise made available, to one or more application instances via their respective application execution environments. As mentioned above, when content is published, the content may include metadata identifying what portions of an application the content is relevant to or otherwise has an effect upon.

The instance configuration settings database typically includes data representative of application instance configurations. In some such embodiments, the data representative of the application instance configurations may include data representative of content deployed to the respective application instances.

The content subscription module 252 typically evaluates the metadata of the content published to the content database. The content subscription module may then query the instance configuration settings database 248 to determine which application instances the new content is relevant to. The new content may then be distributed to the application configuration environments of the identified application instances. The application configuration environment may then deploy the new content.

In embodiments that include a copy of the scoping input database 226, the content subscription module 252 is typically configured to evaluate the scoping information to determine if the published content is relevant to one or more application instances. Depending on the metadata of the published content, this evaluation may identify content relevant to an application instance not identified by the evaluation of the instance configuration settings database 248. Such an identification may occur when a new item of content is published that was not included in the representation of the application instance configuration settings. Such an identification may also occur when the published content is an item of previously existing content whose metadata has been modified.

In embodiments including the content subscription preferences database 250, when an application instance is instantiated, an application administrator, or other individual, may set up a content subscription. A content subscription may include a specification of content subscription preferences that are stored in the content subscription preference database 250. These preferences typically identify how to handle new content when new content is published to the content database 246.

In some embodiments, the content subscription preferences may specify that new content identified by the content subscription module 252 to be relevant to the application instance be pushed to the application configuration environment 102. In some such embodiments, when new content is pushed to the application configuration environment, a content subscription preference may specify that the new content be automatically deployed to the application execution environment 104 by the deployment module 230. In other embodiments, the preferences may specify that the pushed content is to be stored in an administrator inbox. In these embodiments, the administrator, or other individual may manually instruct the deployment module 230 to deploy the new content. In some other embodiments, a content subscription preference may specify for the new content to be placed in a new content inbox. The new content inbox may be located on the content subscription server 106 or other server from which the new content may be accessed for download. In such instances, an application instance administrator may receive a message including a new content notice. The administrator may then go to the designated download location and download the content. The content may then be manually or automatically deployed by the deployment module 230.

In some embodiments, the subscription preferences may specify that new content be sent to an application instance administrator on a computer readable medium, such as via an email, on a computer disk, or other suitable medium. In such instances, the new content may be copied from the computer readable medium to the application configuration environment 102 and deployed in due course.

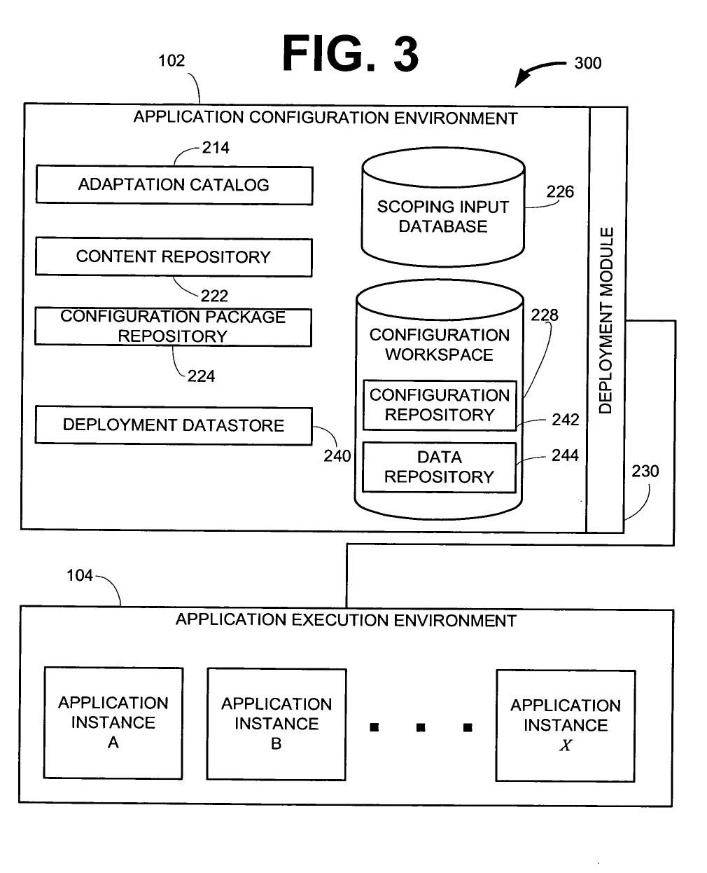

FIG. 3 is a block diagram of a system 300 according to an example embodiment. The system 300 includes the application configuration environment 102 as discussed above with regard to FIG. 1, FIG. 2A, FIG. 2B, and FIG. 2C. The system 300 further includes the application execution environment 104.

The application execution environment 104 is a data processing environment within which an application, or an application to be deployed, may execute. When deploying an application, the deployment module 230 typically needs to know what application execution environment 104 and what application instance within that environment to deploy to. In embodiments including only one application execution environment 104, the application execution environment 104 may already be known. Similarly, in an application execution environment including only a single application instance, the instance may already be known.

Each instance of the application (i.e., application instances A, B, . . . X) typically includes a set of identical configuration tables which may include distinct configuration settings from one another. In some embodiments, multiple instances of the application may exist such as to provide a development instance, a test instance, and a production instance. In such embodiments where there are multiple application instances, the deployment module 230 may deploy the configuration settings from one of the application instances in the application execution environment 104 to another application in the same or another application execution environment 104. Although the deployment module 230 is illustrated as being a part of the application configuration environment 102, the deployment module 230, in other embodiments, may be a standalone application or a part of another application or process.

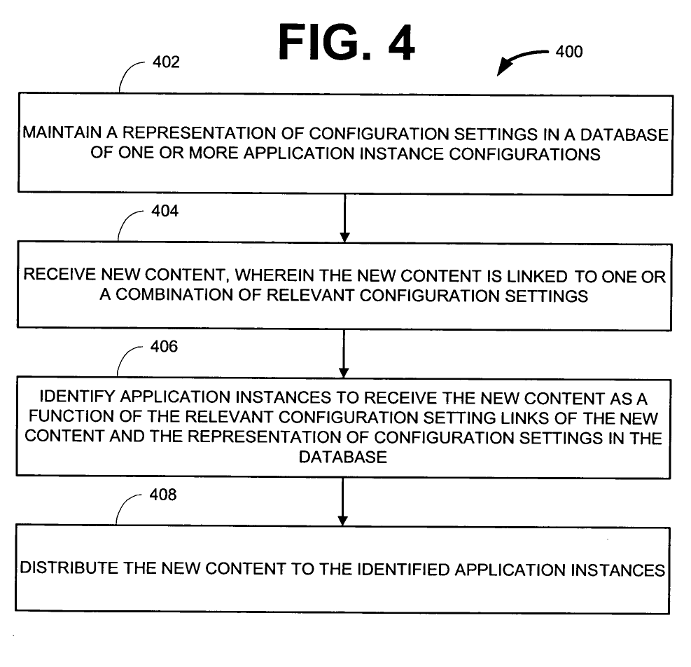

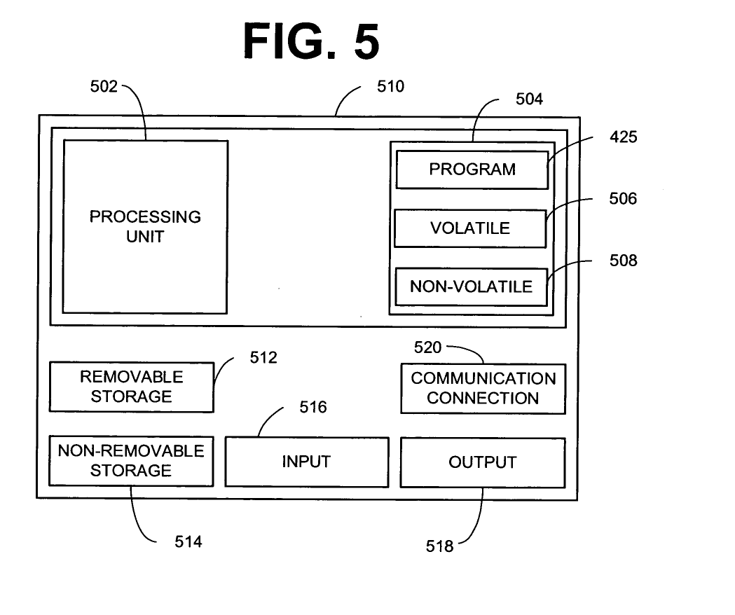

FIG. 4 is a flow diagram of a method 400 according to an example embodiment. The example method 400 includes maintaining a representation of configuration settings in a database of one or more application instance configurations 402 and receiving new content, wherein the new content is linked to one or a combination of relevant configuration settings 404. The method 400 further includes identifying application instances to receive the new content as a function of the relevant configuration setting links of the new content and the representation of configuration settings in the database 406. The method 400 also includes distributing the new content to the identified application instances 408.

Some embodiments of the method 400 include maintaining a database of new content subscription preferences. A new content subscription preference database record can include an application instance identifier and a distribution mode preference. In some such embodiments, the distribution mode preference identifies if new content is to be pushed to the application instance.

FIG. 5 is a block diagram of a computing system according to an example embodiment. In one embodiment, multiple such computer systems are utilized in a distributed network to implement multiple components in a transaction-based environment. An object-oriented architecture may be used to implement such functions and communicate between the multiple systems and components. One example computing device in the form of a computer 510, may include a processing unit 502, memory 504, removable storage 512, and non-removable storage 514. Memory 504 may include volatile memory 506 and non-volatile memory 508. Computer 510 may include—or have access to a computing environment that includes—a variety of computer-readable media, such as volatile memory 506 and non-volatile memory 508, removable storage 512 and non-removable storage 514. Computer storage typically includes random access memory (RAM), read only memory (ROM), erasable programmable read-only memory (EPROM) & electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions. Computer 510 may include or have access to a computing environment that includes input 516, output 518, and a communication connection 520. The computer may operate in a networked environment using a communication connection to connect to one or more remote computers, such as database servers. The remote computer may include a personal computer (PC), server, router, network PC, a peer device or other common network node, or the like. The communication connection may include a Local Area Network (LAN), a Wide Area Network (WAN) or other networks.

Computer-readable instructions stored on a computer-readable medium are executable by the processing unit 502 of the computer 510. A hard drive, CD-ROM, and RAM are some examples of articles including a computer-readable medium. The term “computer readable medium” is also used to represent carrier waves on which the software is transmitted. For example, a computer program 525 capable of providing a generic technique to perform access control check for data access and/or for doing an operation on one of the servers in a component object model (COM) based system according to the teachings of the present invention may be included on a CD-ROM and loaded from the CD-ROM to a hard drive. The computer-readable instructions allow computer 510 to provide generic access controls in a COM based computer network system having multiple users and servers.

It is emphasized that the Abstract is provided to comply with 37 C.F.R. §1.72(b) requiring an Abstract that will allow the reader to quickly ascertain the nature and gist of the technical disclosure. It is submitted with the understanding that it will not be used to interpret or limit the scope or meaning of the claims.

In the foregoing Detailed Description, various features are grouped together in a single embodiment to streamline the disclosure. This method of disclosure is not to be interpreted as reflecting an intention that the claimed embodiments of the invention require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

It will be readily understood to those skilled in the art that various other changes in the details, material, and arrangements of the parts and method stages which have been described and illustrated in order to explain the nature of this invention may be made without departing from the principles and scope of the invention as expressed in the subjoined claims.

What is claimed is:

1. A method comprising:
maintaining a representation of configuration settings in a database of one or more application instance configurations;
receiving new content, wherein the new content is linked to one or a combination of relevant configuration setting representations;
identifying application instances to receive the new content as a function of the relevant configuration setting links of the new content and the representation of configuration settings in the database; and
distributing the new content to the identified application instances.

2. The method of claim 1, further comprising:
maintaining a database of new content subscription preferences, wherein a new content subscription preference database record includes:
an application instance identifier; and
a distribution mode preference.

3. The method of claim 2, wherein the distribution mode preference identifies if new content is to be pushed to the application instance.

4. The method of claim 1, wherein distributing the new content to the identified application instances includes placing the new content in an inbox for an identified application instance to download.

5. The method of claim 1, wherein distributing the new content to the identified application instances includes sending a message to an administrator of an identified application instance notifying the administrator of the new content available for download.

6. The method of claim 1, wherein the new content is a new version of a portion of the application.

7. The method of claim 1, wherein the new content is backward compatible with previously existing application instance content.

8. A machine-readable medium, with encoded instructions, which when executed, cause a machine to:
maintain a representation of configuration settings in a database of one or more application instance configurations;
receive new content, wherein the new content is linked to one or a combination of relevant configuration settings;
identify application instances to receive the new content as a function of the relevant configuration setting links of the new content and the representation of configuration settings in the database; and
distribute the new content to the identified application instances.

9. The machine-readable medium of claim 8, wherein the instructions, when further executed, cause the machine to:
maintain a database of new content subscription preferences, wherein a new content subscription preference database record includes:
an application instance identifier; and
a distribution mode preference.

10. The machine-readable medium of claim 9, wherein the distribution mode preference identifies if new content is to be pushed to the application instance.

11. The machine-readable medium of claim 8, wherein distributing the new content to the identified application instances includes placing the new content in an inbox for an identified application instance to download.

12. The machine-readable medium of claim 8, wherein distributing the new content to the identified application instances includes sending a message to an administrator of an identified application instance notifying the administrator of the new content available for download.

13. The machine-readable medium of claim 8, wherein the new content is a new version of a portion of the application.

14. The machine-readable medium of claim 8, wherein the new content is backward compatible with previously existing application instance content.

15. A system comprising:
a configuration setting database, wherein the configuration setting database stores a representation of configuration settings of one or more application instance configurations;
a content database, wherein new content is published to the content database and is linked to one or a combination of relevant configuration settings possible in the one or more application instance configurations; and
a content subscription module operable to:
identify application instances to receive the new content as a function of the relevant configuration setting links of the new content published to the content database and the representation of configuration settings in the configuration setting database; and
distribute the new content to the identified application instances.

16. The system of claim 15, further comprising:
a database of new content subscription preferences, wherein a new content subscription preference database record includes:
an application instance identifier; and
a distribution mode preference.

17. The system of claim 16, wherein the distribution mode preference identifies if new content is to be pushed to the application instance.

18. The system of claim 15, wherein distributing the new content to the identified application instances includes placing the new content in an inbox for an identified application instance to download from.

19. The system of claim 15, wherein distributing the new content to the identified application instances includes sending a message to an administrator of an identified application instance notifying the administrator of the new content available for download.

20. The system of claim 15, wherein the new content is a new version of a portion of the application.
